(19) United States
(12) Patent Application Publication
(10) Pub. No.: US 2018/0039759 A1
(43) Pub. Date: Feb. 8, 2018

(54) APPARATUSES, METHODS, AND COMPUTER PROGRAM PRODUCTS FOR PROVIDING DIETARY FEEDBACK

(71) Applicant: International Business Machines Corporation, Armonk, NY (US)

(72) Inventors: Tara Astigarraga, Fairport, NY (US); Christopher V. DeRobertis, Hopewell Junction, NY (US); Louie A. Dickens, Tucson, AZ (US); Jose R. Mosqueda Mejia, Puruandiro (MX); Daniel J. Winarski, Tucson, AZ (US)

(21) Appl. No.: 15/230,274

(22) Filed: Aug. 5, 2016

(51) Int. Cl. G06F 19/00

(52) U.S. Cl. CPC G06F 19/3475; G06F 19/3406

(57) ABSTRACT

An apparatus, method, system, and program product are disclosed for providing dietary feedback. One method includes receiving digital information via one or more software applications. The digital information corresponds to a diet of a user. The method also includes determining a quantity of one or more intake nutrients in the diet of the user based on the digital information. The method includes determining a variance between the quantity of the one or more intake nutrients and one or more threshold nutrient levels. The method also includes generating feedback for the user based on the variance. The method includes providing the feedback to a display device.

### FIELD

The subject matter disclosed herein relates to feedback systems and more particularly relates to providing dietary feedback.

### BACKGROUND

Computing devices may include applications to track a user's diet, among other things. Some users carry mobile computing devices that enable input data regarding consumed items to be input. Such consumed items may indicate information relating to the user's health.

### BRIEF SUMMARY

A method for providing dietary feedback is disclosed. An apparatus and computer program product may also perform the functions of the method. In one embodiment, an apparatus includes a data collection module that receives digital information via one or more software applications. In such an embodiment, the digital information corresponds to a diet of a user. The apparatus, in a further embodiment, includes a nutrient evaluation module that determines a quantity of one or more intake nutrients in the diet of the user based on the digital information. In certain embodiments, the apparatus includes a data analysis module that determines a variance between the quantity of the one or more intake nutrients and one or more threshold nutrient levels. In some embodiment, the apparatus includes a feedback generation module that generates feedback for the user based on the variance, and provides the feedback to a display device. In various embodiments, at least a portion of the data collection module, the nutrient evaluation module, the data analysis module and the feedback module includes one or more of hardware and executable code with the executable code being stored on one or more computer readable storage media.

A method for providing dietary feedback is disclosed. In one embodiment, the method includes receiving digital information via one or more software applications. In such an embodiment, the digital information corresponds to a diet of a user. In various embodiments, the method includes determining a quantity of one or more intake nutrients in the diet of the user based on the digital information. In some embodiments, the method includes determining a variance between the quantity of the one or more intake nutrients and one or more threshold nutrient levels. In certain embodiments, the method includes generating feedback for the user based on the variance. In one embodiment, the method includes providing the feedback to a display device.

A computer program product for providing dietary feedback is disclosed. In some embodiments, the computer program product includes a computer readable storage medium having program instructions embodied therewith. In certain embodiments, the program instructions are executable by a processor to cause the processor to receive digital information via one or more software applications. In such embodiments, the digital information corresponds to a diet of a user. In various embodiments, the program instructions are executable by a processor to cause the processor to determine a quantity of one or more intake nutrients in the diet of the user based on the digital information. In certain embodiments, the program instructions are executable by a processor to cause the processor to determine a variance between the quantity of the one or more intake nutrients and one or more threshold nutrient levels. In some embodiments, the program instructions are executable by a processor to cause the processor to generate feedback for the user based on the variance. In various embodiments, the program instructions are executable by a processor to cause the processor to provide the feedback to a display device.

### BRIEF DESCRIPTION OF THE DRAWINGS

In order that the advantages of the embodiments of the invention will be readily understood, a more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a system for providing dietary feedback in accordance with one embodiment of the present invention;

FIG. 2 is a schematic block diagram illustrating one embodiment of a module for providing dietary feedback in accordance with one embodiment of the present invention;

FIG. 3 is a schematic block diagram illustrating one embodiment of another module for providing dietary feedback in accordance with one embodiment of the present invention;

FIG. 4 is a schematic flow chart diagram illustrating one embodiment of a method for providing dietary feedback in accordance with one embodiment of the present invention; and

FIG. 5 is a schematic flow chart diagram illustrating another embodiment of a method for providing dietary feedback in accordance with one embodiment of the present invention.

### DETAILED DESCRIPTION

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, advantages, and characteristics of the embodiments may be combined in any suitable manner. One skilled in the relevant art will recognize that the embodiments may be practiced without one or more of the specific features or advantages of a particular embodiment. In other instances, additional features and advantages may be recognized in certain embodiments that may not be present in all embodiments.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (“RAM”), a read-only memory (“ROM”), an erasable programmable read-only memory (“EPROM” or Flash memory), a static random access memory (“SRAM”), a portable compact disc read-only memory (“CD-ROM”), a digital versatile disk (“DVD”), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (“ISA”) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider). In some embodiments, electronic circuitry including, for example, programmable logic circuitry, field-programmable gate arrays (“FPGA”), or programmable logic arrays (“PLA”) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of program instructions may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

The schematic flowchart diagrams and/or schematic block diagrams in the Figures illustrate the architecture, functionality, and operation of possible implementations. It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Although various arrow types and line types may be employed in the flowchart and/or block diagrams, they are understood not to limit the scope of the corresponding embodiments. Indeed, some arrows or other connectors may be used to indicate only an exemplary logical flow of the depicted embodiment.

The description of elements in each figure may refer to elements of proceeding figures. Like numbers refer to like elements in all figures, including alternate embodiments of like elements.

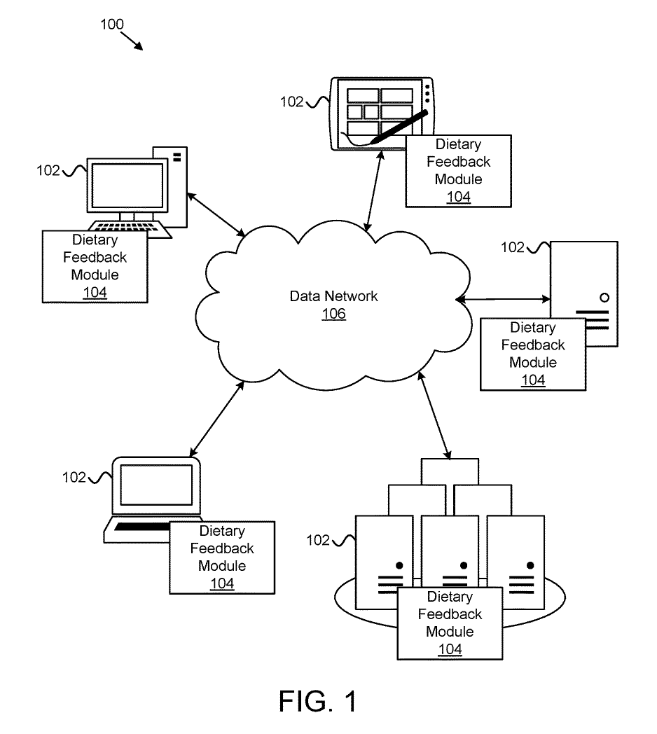

FIG. 1 depicts one embodiment of a system 100 for providing dietary feedback. In one embodiment, the system 100 includes information handling devices 102, dietary feedback modules 104, and data networks 106. Even though a particular number of information handling devices 102, dietary feedback modules 104, and data networks 106 are depicted in the system 100 of FIG. 1, one of skill in the art will recognize that any number or configuration of information handling devices 102, dietary feedback modules 104, and data networks 106 may be present in the system 100.

The information handling devices 102, in certain embodiments, include computing devices, such as desktop computers, laptop computers, tablet computers, smart phones, smart televisions, fitness trackers, activity trackers, personal electronic devices, smart watches, or the like. The information handling devices 102 may also include servers, such as web servers, application servers, file servers, media servers, email servers, cloud servers, backup servers, virtual servers, or the like. In some embodiments, the information handling devices 102 may be part of a data center used for data storage, data backup, data replication, disaster recovery, mirroring, and/or the like. The information handling devices 102 may be located in geographically remote locations, in the same geographic location (e.g., the same data center), or some combination of both.

The information handling devices 102 may be configured to store data, backup data, replicate data, or the like. For example, the information handling devices 102 may be configured to perform synchronous or asynchronous data replication. In another example, information handling devices 102 may be configured as failover devices for one or more associated information handling devices 102. Moreover, the information handling devices 102 may include one or more storage volumes, storage devices, redundant array of independent disks (“RAID”) devices or configurations, or the like, such as hard-disk drives, solid-state drives, flash memory devices, random-access memory (“RAM”), serial advanced technology attachment (“SATA”) devices, tape devices, or the like. In some embodiments, the information handling devices 102 are in communication via one or more data networks 106, described below. In various embodiments, the information handling devices 102 may include a display, a speaker, a microphone, and so forth.

In one embodiment, the dietary feedback module 104 receives digital information via one or more software applications. In such an embodiment, the digital information corresponds to a diet of a user. In some embodiments, the dietary feedback module 104 determines a quantity of one or more intake nutrients in the diet of the user based on the digital information. In certain embodiments, the dietary feedback module 104 determines a variance between the quantity of the one or more intake nutrients and one or more threshold nutrient levels. In various embodiments, the dietary feedback module 104 generates feedback for the user based on the variance. In one embodiments, the dietary feedback module 104 provides the feedback to a display device. In this manner, the dietary feedback module 104 may facilitate providing dietary feedback to a user to enable the user to consume a desired quantity of nutrients.

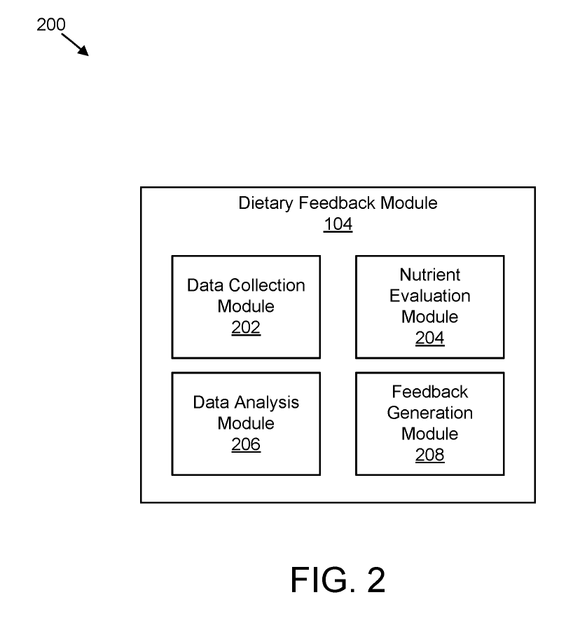

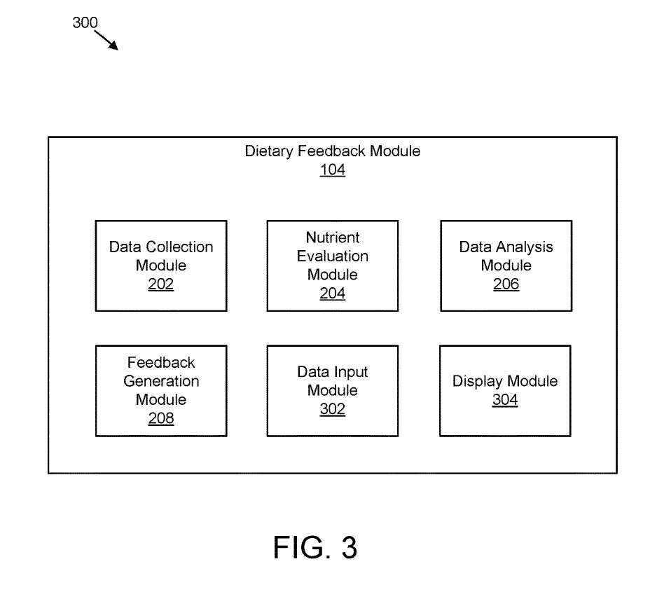

As may be appreciated, the dietary feedback module 104 may be used in any suitable system 100. In certain embodiments, as described below with reference to FIGS. 2 and 3, the dietary feedback module 104 includes multiple modules that perform the operations of the dietary feedback module 104.

The data network 106, in one embodiment, includes a digital communication network that transmits digital communications. The data network 106 may include a wireless network, such as a wireless cellular network, a local wireless network, such as a Wi-Fi network, a Bluetooth® network, a near-field communication (“NFC”) network, an ad hoc network, and/or the like. The data network 106 may include a wide area network (“WAN”), a storage area network (“SAN”), a local area network (“LAN”), an optical fiber network, the internet, or other digital communication network. The data network 106 may include two or more networks. The data network 106 may include one or more servers, routers, switches, and/or other networking equipment. The data network 106 may also include computer readable storage media, such as a hard disk drive, an optical drive, non-volatile memory, RAM, or the like.

FIG. 2 is a schematic block diagram illustrating one embodiment of a module 200 for providing dietary feedback. In one embodiment, the module 200 includes an embodiment of a dietary feedback module 104. The dietary feedback module 104, in various embodiments, includes one or more of a data collection module 202, a nutrient evaluation module 204, a data analysis module 206, and a feedback generation module 208, which are described in more detail below.

In one embodiment, the data collection module 202 receives digital information via one or more software applications. The digital information corresponds to a diet of a user. For example, the digital information may include information corresponding to food, drink, supplements, and/or medications consumed by the user over a predetermined period of time (e.g., day, week, month, etc.). The one or more software applications may include any suitable software application, such as a database, a meal planner, a food tracker, a calorie tracker, a health tracker, a fitness tracker, and/or Chef Watson developed by IBM with headquarters in Armonk, N.Y. The predetermined period of time may include any suitable period of time for which the diet may be analyzed to determine a quantity of nutrients consumed by the user over the predetermined period of time. Moreover, in certain embodiments, the predetermined period of time may match a time period corresponding to a recommended consumption of a nutrient. For example, the predetermined period of time may be one day, and the consumption of vitamin C for the user for a day may be determined to be compared to a recommended daily consumption of vitamin C. As used herein, the term “diet” may refer to anything consumed by a person (e.g., a user of an information handling device). For example, diet may refer to the consumption of food, drink, supplements, and/or medications.

In certain embodiments, the digital information may include information corresponding to items not consumed by the user. For example, a user may desire to see how consuming certain foods, drinks, supplements, and/or medicines will affect their nutrient intake. Accordingly, the user may input information relating to potential foods, drinks, supplements, and/or medicines to be consumed, and the digital information may include the information input by the user.

The data collection module 202 may include any suitable software for connecting to other software applications for retrieving data from the other software applications. In some embodiments, the data collection module 202 includes an interface that enables the user to manually enter items consumed. The data collection module 202 may store digital information received and/or manually input in a database and/or a data structure for analysis.

The nutrient evaluation module 204, in one embodiment, determines a quantity of one or more intake nutrients in the diet of the user based on the digital information. In certain embodiments, the nutrient evaluation module 204 determines a quantity of more than one intake nutrient in the diet of the user; while in other embodiments, the nutrient evaluation module 204 determines only one intake nutrient in the diet of the user. In some embodiments, the nutrient evaluation module 204 analyzes the digital information to determine the quantity of intake nutrients such as a vitamin, a mineral, a micronutrient, and a macronutrient. The quantity of intake nutrients may be determined for what was consumed over a predetermined period of time.

A vitamin may refer to a natural substance that is usually found in foods and that helps the body to be healthy. For example, a vitamin may include vitamin A, vitamin B₁, vitamin B₂, vitamin B₃, vitamin B₅, vitamin B₆, vitamin B₇, vitamin B₉, vitamin B₁₂, vitamin C, vitamin D, vitamin E, vitamin K₁, and/or vitamin K₂. A mineral may refer to a chemical element required as an essential nutrient by organisms. For example, a mineral may include potassium, chloride, sodium, calcium, phosphorus, magnesium, iron, zinc, manganese, copper, iodine, chromium, molybdenum, selenium, and/or cobalt. A micronutrient may refer to nutrients required by organisms in small quantities to orchestrate a range of physiological functions. For example, a micronutrient may refer to various vitamins and/or minerals that are needed in small quantities, phytochemicals, and so forth. A macronutrient may refer to a class of chemical compounds that humans consume in the largest quantities. For example, a macronutrient may refer to a carbohydrate, a protein, and/or a fat.

In certain embodiments, the nutrient evaluation module 204 computes a sum of a quantity of each determined intake nutrient in the diet of the user for a predetermined period of time based on the digital information. In some embodiments, the nutrient evaluation module 204 may determine diet patterns and/or habits of the user. The diet patterns and/or habits may be used to predict quantities of intake nutrients for the user based on only a portion of consumed items being entered into a software application by a user.

The nutrient evaluation module 204 may obtain nutrient information (e.g., a quantity of each nutrient) corresponding to the digital information using any suitable source. In certain embodiments, the nutrient evaluation module 204 may access a database (e.g., external database, internal database) that includes nutrient information for foods, drinks, supplements, and/or medicines. In some embodiments, the nutrient evaluation module 204 may access a network resource that includes nutrient information for foods, drinks, supplements, and/or medicines.

In certain embodiments, the data analysis module 206 determines a variance between the quantity of the one or more intake nutrients and one or more threshold nutrient levels. In some embodiments, the data analysis module 206 determines an amount of a difference between the quantity of the one or more intake nutrients and the one or more threshold nutrient levels. In various embodiments, the one or more threshold nutrient levels include a threshold nutrient level such as a minimum nutrient level, a maximum nutrient level, and/or a nutrient range. For example, threshold nutrient levels for vitamin C may include a minimum nutrient level of 90 mg, a maximum nutrient level of 2,000 mg, and a range of 90 mg to 2,000 mg for an adult male over 19 years old for one day. Accordingly, in such an example, if the quantity of vitamin C consumed by an adult male over 19 years old in one day is 80 mg, the difference between the quantity of vitamin C consumed and the minimum nutrient level is 10 mg (e.g., 90 mg-80 mg). In various embodiments, the data analysis module 206 may use nutrition analytics to determine the variance and to determine feedback for the user.

In some embodiments, the data analysis module 206 may select which intake nutrients to analyze based on a user selection of desired intake nutrients to analyze. Accordingly, the data analysis module 206 may receive user input selections to select the desired intake nutrients to analyze. In certain embodiments, the data analysis module 206 may enable other software applications to access information determined by the dietary feedback module 104, such as via a service or external API call. In some embodiments, a user, doctor, health advisor, and so forth may use the information determined by the dietary feedback module 104 to track the health of the user and/or suggest dietary changes for the user.

In various embodiments, the feedback generation module 208 generates feedback for the user based on the variance. In certain embodiments, the feedback generation module 208 provides the feedback to a display device. In one embodiment, the feedback generation module 208 generates the feedback for the user based on the variance by determining a nutrient supplement for the user to add to and/or remove from the diet. In such an embodiment, the nutrient supplement may include one or more of a vitamin, a mineral, a micronutrient, and/or a macronutrient. Returning to the example above relating to vitamin C, in such an example, the feedback generation module 208 may generate feedback for the user that the user needs to take a vitamin C supplement.

In some embodiments, the feedback generation module 208 generates the feedback for the user based on the variance by determining dietary changes for the user. For example, the dietary changes may include a food to be eaten, a food not to be eaten, a drink to consume, a drink not to consume, a meal to be eaten, and/or a meal not to be eaten.

The feedback generation module 208 may generate feedback that is specific to the user based on the user's demographics. For example, the feedback may be based on a user's age and gender. Accordingly, the feedback generation module 208 may obtain the user's demographics prior to generating the feedback for the user.

In certain embodiments, the dietary feedback module 104 may be used for a group of people (e.g., user group), such as a family, a team, a nutritional group, a fitness group, and so forth. In such embodiments, the digital information described herein may correspond to the diet of a user group, and the feedback generation module 208 may generate feedback for the user group. Furthermore, the feedback provided to the user group (or an individual user) may be tailored to a location and/or demographic of the user group. In certain embodiments, a food that is in a particular geographic region and/or used by a particular demographic may be recommended as a source for a desired nutrient. For example, if a user group needs to increase vitamin C in countries such as Mexico, the United States of America, or United Arab Emirates, different fruits may be suggested as dietary feedback and may be based on the season of the year and/or the availability of such fruits.

In certain embodiments, at least a portion of the data collection module 202, the nutrient evaluation module 204, the data analysis module 206, and the feedback generation module 208 include one or more of hardware and executable code. In such embodiments, the executable code may be stored on one or more computer readable storage media.

As described herein, the dietary feedback module 104 may help a user maintain nutrient levels appropriate for the user. For example, a user may be using a blood thinner medication (e.g., warfarin, Coumadin®). The dietary feedback module 104 may receive digital information indicating that the user is using a blood thinner medication. Accordingly, the dietary feedback module 104 may also receive other consumption information corresponding to the user. Based on the consumption information, the dietary feedback module 104 may determine whether the user is consuming a suitable amount of vitamin K that is appropriate for a user using the blood thinner. Furthermore, the dietary feedback module 104 may provide feedback to the user about when to increase and/or decrease consumption of vitamin K (e.g., such as by providing feedback to increase and/or decrease consumption of specific foods and/or drinks). Therefore, the dietary feedback module 104 may facilitate stabilizing the user's consumption of vitamin K.

As another example, the dietary feedback module 104 may receive consumption information corresponding to a user. Based on the consumption information, the dietary feedback module 104 may determine whether the user is consuming a suitable amount of calcium for a specific demographic (e.g., age, gender, etc.). Furthermore, the dietary feedback module 104 may provide feedback to the user about when to increase and/or decrease consumption of calcium (e.g., such as by providing feedback to increase and/or decrease consumption of specific foods and/or drinks). For example, the dietary feedback module 104 may provide feedback indicating for the user to decrease consumption of milk. Therefore, the dietary feedback module 104 may facilitate stabilizing the user's consumption of calcium. As described herein, the dietary feedback module 104 may facilitate consumption of appropriate nutrient quantities. As such, the dietary feedback module 104 may facilitate reduction in medical problems and/or medical testing.

FIG. 3 is a schematic block diagram illustrating one embodiment of another module 300 for providing dietary feedback. In one embodiment, the module 300 includes an embodiment of a dietary feedback module 104. The dietary feedback module 104, in various embodiments, includes one or more of a data collection module 202, a nutrient evaluation module 204, a data analysis module 206, and a feedback generation module 208, which may be substantially similar to the data collection module 202, the nutrient evaluation module 204, the data analysis module 206, and the feedback generation module 208 described above. The dietary feedback module 104 may also include one or more of a data input module 302 and a display module 304, which are described in more detail below.

In one embodiment, the data input module 302 obtains digital information via one or more software applications. The digital information may correspond to a diet of a user. The digital information may include information corresponding to food, drink, supplements, and/or medications consumed by the user over a predetermined period of time (e.g., day, week, month, etc.). The one or more software applications may include any suitable software application, such as a database, a meal planner, a food tracker, a calorie tracker, a health tracker, a fitness tracker, and/or Chef Watson developed by IBM with headquarters in Armonk, N.Y. The predetermined period of time may include any suitable period of time for which the diet may be analyzed to determine a quantity of nutrients consumed by the user over the predetermined period of time. Moreover, in certain embodiments, the predetermined period of time may compare to a recommended consumption of a nutrient over the predetermined period of time.

The data input module 302 may include any suitable software for connecting to other software applications for retrieving data from the other software applications. In some embodiments, the data input module 302 includes an interface that enables the user to manually enter items consumed. The data input module 302 may store retrieved and/or input data in a database and/or a data structure for analysis.

The display module 304, in certain embodiments, provides the feedback to a display device. In some embodiments, the display module 304 includes the display device; while, in other embodiments, the display module 304 transmits the feedback to the display device.

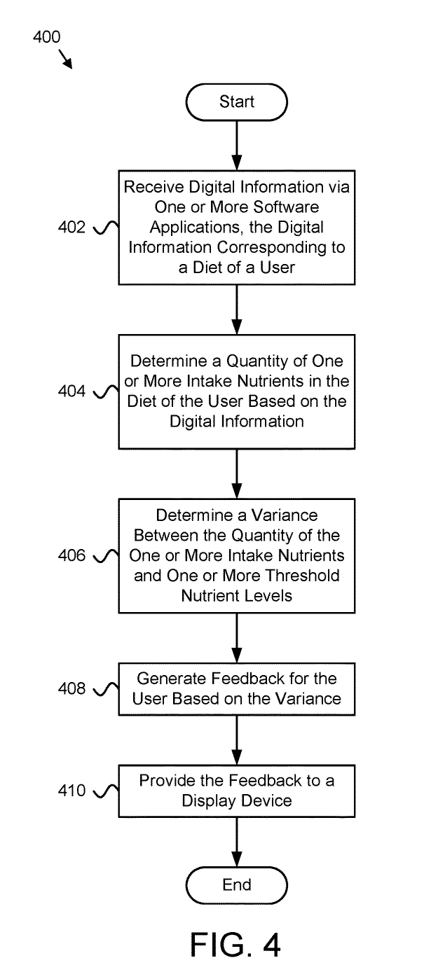

FIG. 4 is a schematic flow chart diagram illustrating one embodiment of a method 400 for providing dietary feedback. In certain embodiments, the method 400 may be performed by the dietary feedback module 104. In one embodiment, the method 400 begins and receives 402 digital information via one or more software applications. The digital information may correspond to a diet of a user. In some embodiments, the data collection module 202 receives 402 the digital information. In various embodiments, the digital information includes information corresponding to food, drink, supplements, and medications consumed by the user over a predetermined period of time. In certain embodiments, the digital information includes information corresponding to items not consumed by the user. In one embodiment, the one or more software applications includes a software application such as a database, a meal planner, a food tracker, a calorie tracker, and/or a fitness tracker.

The method 400 may determine 404 a quantity of one or more intake nutrients in the diet of the user based on the digital information. In one embodiment, the nutrient evaluation module 204 may determine 404 the quantity of the one or more intake nutrients in the diet of the user based on the digital information. In certain embodiments, determining 404 the quantity of the one or more intake nutrients in the diet of the user based on the digital information includes analyzing the digital information to determine the quantity of a nutrient selected from the group consisting of a vitamin, a mineral, a micronutrient, and/or a macronutrient. In some embodiments, determining 404 the quantity of the one or more intake nutrients in the diet of the user based on the digital information includes computing a sum of a quantity of each determined intake nutrient in the diet of the user based on the digital information.

The method 400 may determine 406 a variance between the quantity of the one or more intake nutrients and one or more threshold nutrient levels. In one embodiment, the data analysis module 206 may determine 406 the variance between the quantity of the one or more intake nutrients and the one or more threshold nutrient levels. In certain embodiments, determining 406 the variance between the quantity of the one or more intake nutrients and the one or more threshold nutrient levels includes determining an amount of a difference between the quantity of the one or more intake nutrients and the one or more threshold nutrient levels. In various embodiments, the one or more threshold nutrient levels include a threshold nutrient level such as a minimum nutrient level, a maximum nutrient level, and/or a nutrient range.

In certain embodiments, determining 406 the variance may be performed using the following equation: Z=(X −Average)/(Standard Deviation). In this equation, Z represents a normalization of a variance; the X may represent a user's consumption of a nutrient; the Average may represent a running average consumption of the nutrient; the Standard Deviation may represent a standard deviation of the user's consumption of the nutrient. The Standard Deviation may assume a Gaussian Distribution on the variance. In some embodiments, it may be determined whether Z exceeds a threshold (e.g., either higher than a maximum variance “Zmax” or lower than a minimum variance “Zmin”). In various embodiments, Z may be a standardized normal variance. In one embodiment, if Z=0, then the measurement of X is equal to the Average; if Z=+1, then the measurement is one standard deviation above the Average; if Z=+2, then the measurement is two standard deviations above the Average; if Z=−1, then the measurement X is one standard deviation below the Average; if Z=−2, then the measurement X is two standard deviations below the Average; and so forth.

In various embodiments, if X represents a critical nutrient (e.g., Zinc), then a Zmax of +1 and/or a Zmin of −1 may trigger an alert to the user and/or friends of the user (e.g., via social media alerts). In some embodiments, a Zmax of +2 and/or a Zmin of −2 may trigger alarms to medical personnel. As may be appreciated, the thresholds Zmax and Zmin may not be equal in value. For example, a Zmax may be +1 and a Zmin may be −0.5. Moreover, in some embodiments, the thresholds Zmax and Zmin may vary for different portions of a user's diet. For example, for certain nutrients, a Zmax of +0.5 and/or a Zmin of −0.5 may trigger an alert instead of a Zmax of +1 and/or a Zmin of −1. It should be noted that certain examples of Zmax and Zmin are provided herein; however, any suitable values of Zmax and Zmin may be used.

The method 400 may generate 408 feedback for the user based on the variance. In one embodiment, the feedback generation module 208 may generate 408 the feedback for the user based on the variance. In certain embodiments, generating 408 the feedback for the user based on the variance includes determining a nutrient supplement for the user to add to the diet. In such embodiments, the nutrient supplement includes a supplement such as a vitamin, a mineral, a micronutrient, and/or a macronutrient. In some embodiments, generating 408 the feedback for the user based on the variance includes determining dietary changes for the user. In such embodiments, the dietary changes include a change such as a food to be eaten, a food not to be eaten, a drink to consume, a drink not to consume, a meal to be eaten, and/or a meal not to be eaten. In some embodiments, the digital information corresponds to the diet of a user group, and generating 408 the feedback for the user based on the variance includes generating the feedback for the user group based on the variance.

The method 400 may provide 410 the feedback to a display device, and the method 400 may end. In one embodiment, the feedback generation module 208 may provide 410 the feedback to the display device.

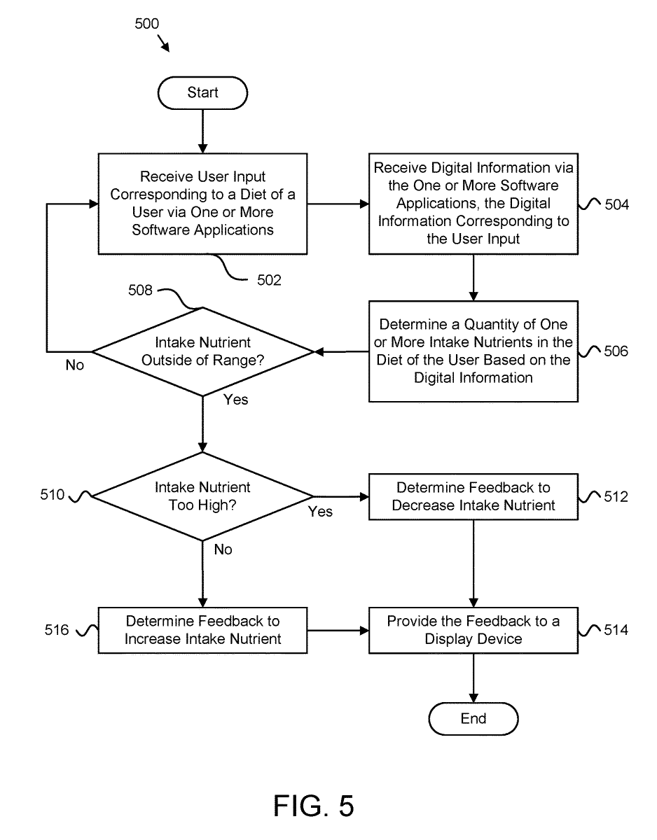

FIG. 5 is a schematic flow chart diagram illustrating another embodiment of a method 500 for providing dietary feedback. In certain embodiments, the method 500 may be performed by the dietary feedback module 104. In one embodiment, the method 500 begins and receives 502 user input corresponding to a diet of a user via one or more software applications. In various embodiments, the data input module 302 receives 502 the user input corresponding to the diet of the user via the one or more software applications. In one embodiment, the one or more software applications includes a software application such as a database, a meal planner, a food tracker, a calorie tracker, and/or a fitness tracker.

In certain embodiments, the method 500 receives 504 digital information via the one or more software applications. The digital information may correspond to a diet of a user. In some embodiments, the data collection module 202 receives 504 the digital information. In various embodiments, the digital information includes information corresponding to food, drink, supplements, and medications consumed by the user over a predetermined period of time. In certain embodiments, the digital information includes information corresponding to items not consumed by the user.

The method 500 may determine 506 a quantity of one or more intake nutrients in the diet of the user based on the digital information. In one embodiment, the nutrient evaluation module 204 may determine 506 the quantity of the one or more intake nutrients in the diet of the user based on the digital information. In certain embodiments, determining 506 the quantity of the one or more intake nutrients in the diet of the user based on the digital information includes analyzing the digital information to determine the quantity of a nutrient selected from the group consisting of a vitamin, a mineral, a micronutrient, and/or a macronutrient. In some embodiments, determining 506 the quantity of the one or more intake nutrients in the diet of the user based on the digital information includes computing a sum of a quantity of each determined intake nutrient in the diet of the user based on the digital information.

The method 500 may determine 508 whether the quantity of an intake nutrient of the one or more intake nutrients is outside of a range. In one embodiment, the data analysis module 206 may determine 508 whether the quantity of the intake nutrient of the one or more intake nutrients is outside of the range. In certain embodiments, determining 508 whether the quantity of the intake nutrient of the one or more intake nutrients is outside of the range may be determined in response to the variance Z being determined as set forth above in block 406 of FIG. 4 and the variance Z exceeding a maximum threshold and/or exceeding a minimum threshold. If the quantity of the intake nutrient is within the range, the method 500 may return to receiving 502 user input.

If the quantity of the intake nutrient is outside of the range, the method 500 may determine 510 whether the quantity of the intake nutrient is too high. If the quantity of the intake nutrient is too high, the method 500 may determine 512 feedback to decrease the quantity of the intake nutrient. For example, the feedback to decrease the quantity of the intake nutrient may include feedback to avoid consumption of certain foods and/or drinks, feedback to follow a certain meal plan, feedback to reduce consumption of certain foods and/or drinks, and so forth. In one embodiment, the feedback generation module 208 may determine 512 the feedback to decrease the quantity of the intake nutrient.

The method 500 may provide 514 the feedback to a display device, and the method 500 may end. In one embodiment, the display module 304 may provide 514 the feedback to the display device.

If the quantity of the intake nutrient is too low, the method 500 may determine 516 feedback to increase the quantity of the intake nutrient. For example, the feedback to increase the quantity of the intake nutrient may include feedback to begin consuming certain foods and/or drinks, feedback to follow a certain meal plan, feedback to increase consumption of certain foods and/or drinks, and so forth. In one embodiment, the feedback generation module 208 may determine 516 the feedback to increase the quantity of the intake nutrient. The method 500 may provide 514 the feedback to the display device.

The embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus comprising:
a data collection module that receives digital information via one or more software applications, wherein the digital information corresponds to a diet of a user;
a nutrient evaluation module that determines a quantity of one or more intake nutrients in the diet of the user based on the digital information;
a data analysis module that determines a variance between the quantity of the one or more intake nutrients and one or more threshold nutrient levels; and
a feedback generation module that:
generates feedback for the user based on the variance; and
provides the feedback to a display device;
wherein at least a portion of the data collection module, the nutrient evaluation module, the data analysis module and the feedback module comprises one or more of hardware and executable code,
the executable code being stored on one or more computer readable storage media.

2. The apparatus of claim 1, wherein the digital information comprises information corresponding to food, drink, supplements, and medications consumed by the user over a predetermined period of time.

3. The apparatus of claim 1, wherein the digital information comprises information corresponding to items not consumed by the user.

4. The apparatus of claim 1, wherein the one or more software applications comprise a software application selected from the group consisting of a database, a meal planner, a food tracker, a calorie tracker, a fitness tracker, and combinations thereof.

5. The apparatus of claim 1, wherein the one or more threshold nutrient levels comprises a threshold nutrient level selected from the group consisting of a minimum nutrient level, a maximum nutrient level, a nutrient range, and combinations thereof.

6. The apparatus of claim 1, wherein the digital information corresponds to the diet of a user group, and the feedback module generates feedback for the user group based on the variance.

7. A method for providing dietary feedback, comprising:
receiving digital information via one or more software applications, wherein the digital information corresponds to a diet of a user;
determining a quantity of one or more intake nutrients in the diet of the user based on the digital information;
determining a variance between the quantity of the one or more intake nutrients and one or more threshold nutrient levels;
generating feedback for the user based on the variance; and
providing the feedback to a display device.

8. The method of claim 7, wherein the digital information comprises information corresponding to food, drink, supplements, and medications consumed by the user over a predetermined period of time.

9. The method of claim 7, wherein the digital information comprises information corresponding to items not consumed by the user.

10. The method of claim 7, wherein the one or more software applications comprise a software application selected from the group consisting of a database, a meal planner, a food tracker, a calorie tracker, a fitness tracker, and combinations thereof.

11. The method of claim 7, wherein determining the quantity of the one or more intake nutrients in the diet of the user based on the digital information comprises analyzing the digital information to determine the quantity of a nutrient selected from the group consisting of a vitamin, a mineral, a micronutrient, a macronutrient, and combinations thereof.

12. The method of claim 7, wherein determining the quantity of the one or more intake nutrients in the diet of the user based on the digital information comprises computing a sum of a quantity of each determined intake nutrient in the diet of the user based on the digital information.

13. The method of claim 7, wherein determining the variance between the quantity of the one or more intake nutrients and the one or more threshold nutrient levels comprises determining an amount of a difference between the quantity of the one or more intake nutrients and the one or more threshold nutrient levels.

14. The method of claim 7, wherein the one or more threshold nutrient levels comprises a threshold nutrient level selected from the group consisting of a minimum nutrient level, a maximum nutrient level, a nutrient range, and combinations thereof.

15. The method of claim 7, wherein generating the feedback for the user based on the variance comprises determining a nutrient supplement for the user to add to the diet.

16. The method of claim 15, wherein the nutrient supplement comprises a supplement selected from the group consisting of a vitamin, a mineral, a micronutrient, a macronutrient, and combinations thereof.

17. The method of claim 7, wherein generating the feedback for the user based on the variance comprises determining dietary changes for the user.

18. The method of claim 17, wherein the dietary changes comprise a change selected from the group consisting of a food to be eaten, a food not to be eaten, a drink to consume, a drink not to consume, a meal to be eaten, a meal not to be eaten, and combinations thereof.

19. The method of claim 7, wherein the digital information corresponds to the diet of a user group, and generating the feedback for the user based on the variance comprises generating the feedback for the user group based on the variance.

20. A computer program product for providing dietary feedback, the computer program product comprising a computer readable storage medium having program instructions embodied therewith, the program instructions executable by a processor to cause the processor to:
receive digital information via one or more software applications, wherein the digital information corresponds to a diet of a user;
determine a quantity of one or more intake nutrients in the diet of the user based on the digital information;
determine a variance between the quantity of the one or more intake nutrients and one or more threshold nutrient levels;
generate feedback for the user based on the variance; and
provide the feedback to a display device.
